(19) United States
(12) Patent Application Publication
(10) Pub. No.: US 2010/0301252 A1
(43) Pub. Date: Dec. 2, 2010

(54) Universal Valve System

(76) Inventors: Arne Fridtjof Myran, Vanvikan (NO); David Shipway Laker, Milford, NH (US)

Correspondence Address: Arne Fridtjof Myan;c/o Dave Laker, 10201 N. Concord Drive, Mequon, WI, 53097, US

(21) Appl. No.: 12/476,528

(22) Filed: Jun. 2, 2009

(51) Int. Cl. F16K 3/00; F16K 27/00

(52) U.S. Cl. 251/326; 251/366

(57) ABSTRACT

The universal valve disclosed herein operates as both an actuated and non-actuated valve embodiment, both of which are assembled using a common universal valve body. When functioning in the actuated valve embodiment, the invention includes components which open a small orifice to provide pressurization or de-pressurization before the disk is lifted off the seat and the poppet valve is opened.

### FIELD OF INVENTION

This invention relates to the field of valves specifically designed for the control of fluids in an energy recovery device used in the process of desalination of a solute, typically seawater, by reverse osmosis, and in particular, to a universal valve which may be configured as either a non-actuated valve or an actuated valve that utilizes interchangeable components in a manner which reduces the energy required to actuate the valve while also improving fluid dynamics.

### BACKGROUND

Reverse osmosis is a process which uses a force that is in reverse of the normal osmotic pressure to force a solution containing a solute (e.g., seawater) through a semi-permeable membrane. This process has the effect of splitting the solute stream into a permeate stream and a waste stream. The permeate stream has a very low salt content and is typically potable. The waste stream has a higher concentration of salt than the solute and is known as “concentrate.”

The reverse osmosis process requires substantial energy to separate the solute into a permeate stream and a concentrate stream using semi-permeable membranes. This energy is primarily required to power high-pressure pumps that are used to drive fluids through the membranes.

A work exchanger is an energy recovery device used to reduce the net energy required by the reverse osmosis process by recovering the potential (pressure) energy contained in the concentrate leaving the reverse osmosis (semi-permeable) membrane module. The amount of potential energy contained in the concentrate stream is typically sixty percent (60%) of the total energy required by the reverse osmosis process when applied to a solute such as seawater.

Work exchanger energy recovery devices have the potential to increase efficiency by recovering as much as ninety-eight percent (98%) of the potential energy contained in the concentrate stream.

The process of recovering the energy from the concentrate stream is achieved by directing the concentrate stream directly against the low-pressure solute about to be desalinated immediately before it contacts the membranes of the reverse osmosis component of the desalination device. This is accomplished by placing a vessel filled with solute at atmospheric or slightly above atmospheric pressure in contact with the concentrate stream that is at high-pressure. The high-pressure is transferred virtually instantly to the low-pressure solute that becomes pressurized to the same level as the high-pressure concentrate stream. This process is made continuous by a work exchanger system, typically comprised of pairs of pressure vessels operating in an appropriate sequence.

Each pressure vessel has at least two ports: a concentrate port at one end, and a solute port at the other end. Each pair of vessels may further include a component (referred to herein as a “septum”) which freely slides between the ports (or, alternatively, the interface between the high-pressure and low-pressure fluids may serve as the septum). A system of valves connect and disconnect the concentrate ports to a high-pressure waste stream concentrate line, a low-pressure discharge concentrate line, a low-pressure solute (feed) line and a high-pressure solute (feed) line.

Each pressure vessel performs a two-stroke cycle. At the first stroke, the concentrate port is connected to the high-pressure concentrate line, while the feed port is connected to the high-pressure feed line. The vessel is filled with high-pressure concentrate that displaces the septum back toward the feed port to direct feed into the high-pressure feed line and toward the reverse osmosis membranes.

At the second stroke, the concentrate port is connected to the concentrate discharge line while the feed port is connected to the low-pressure solute feed line. The vessel is filled with low-pressure feed that displaces the septum towards the concentrate port and concentrate is discharged through the non- or low-pressurized discharge line.

The foregoing discussion describes a two-vessel, two-port embodiment, but other embodiments may include additional vessels or ports.

Valve design is critical to the operation of a work exchanger device. A typical work exchange system includes-various configurations of valves which control the flow of pressurized solute, typically seawater, and concentrate through the reverse osmosis process and which are used to make the process continuous. Hereafter the discussion will focus on seawater as the solute.

A work exchange device is comprised of one or more pairs of vessels. Each vessel includes two types of valves: a seawater valve type and a concentrate valve type. The seawater valves are generally non-actuated check valves that open and close in response to the pressure and flow of concentrate through the actuated concentrate valves.

An actuator controls the concentrate valve type. The concentrate valves are opened and closed to control the flow of high-pressure concentrate into the vessel and the discharge of the de-pressurized concentrate. The concentrate valves may be poppet style valves, butterfly, ball, spool or other valves known in the art. Electric, hydraulic, pneumatic, or any other practical type of valve actuator may actuate these valves.

The operation of the work exchanger system requires special timing, reliable synchronization and sealing of the valves in order to efficiently perform the two-stroke cycle.

Work exchanger devices having various valve configurations are known in the art, including spool valve and poppet valve configurations. Poppet valves are often chosen for their simplicity and control. In particular, work exchangers using four actuated poppet valves are known in the art. Spool valves are also frequently used in work exchanger devices.

Work exchangers typically require cross-configuration of multiple valves (i.e., that the valves be connected to one another) in order to achieve balanced pressure over a single valve. This need for cross-configuration of multiple valves limits the potential design and configuration of valves within, work, exchanger systems and the ability to design systems corresponding to the needs of particular projects.

Additionally, many work exchangers known in the art utilize valves with large diameter ports and disks, which result in rapid pressurization and de-pressurization when the valves are opened and closed. This, in turn, can result in undesirable cavitation, and the phenomena of “water hammer.”

It is desirable to have a valve system that allows for customized manufacturing and interchangeability of component parts of concentrate and feed valves in order to maximize the valve sealing capability and improve control and synchronization of the opening and closing of valves.

It is desirable to achieve the advantages of using poppet valves in a work exchanger without the need for complex cross-configuration of valves that limits potential design configurations of work exchanger systems.

It is desirable to reduce the amount of energy required to operate a valve, and to efficiently pressurize and depressurize the vessels of a work exchanger to ease the physical load on the actuator.

It is desirable to have a standardized valve design incorporating interchangeable component parts that can be used universally within a work exchanger device to control the flow and discharge of concentrate and seawater under a wide range of pressurization, systemic and process conditions.

It is desirable to design a work exchanger system which minimizes the phenomena of cavitation and “water hammer” which can cause noise, damage to components and wear from vibrations, without compromising the efficiency, reliability and longevity of a work exchanger system.

It is further desirable to reduce the amount of energy required to operate a valve, and to efficiently control the pressure within an individual valve to decrease the energy required to operate the valve as pressurizing and depressurizing the vessels of a work exchanger eases the physical load on the actuator.

Glossary

As used herein, the term “actuated” means moved by an actuator.

As used herein, the term “actuated valve” means an embodiment of a universal valve that is controlled by an actuator (e.g. including but not limited to a concentrate valve as discussed in exemplary embodiments herein). The actuated (e.g., concentrate) valves are opened and closed to control the flow of high-pressure concentrate into the vessel and the discharge of the de-pressurized concentrate. The concentrate valves may be poppet style valves, butterfly, ball, spool or other valves known in the art. These valves may be actuated by electric, hydraulic, pneumatic or any other practical type of valve actuator.

As used herein, the term “actuator” means any mechanized method of moving a valve component including but not limited to a hydraulic actuator, a pneumatic actuator, an electric actuator or any other actuator known in the art.

As used herein, the term “actuated stem assembly” means a stem assembly, which is configured so that an actuator may be attached to move the actuated stem assembly.

As used herein, the term “balance” means a condition of moving toward a state of pressure equalization or equilibrium.

As used herein, the term “complementary” means one component or feature which operates in conjunction with another component or feature to enhance functionality.

As used herein, the term “concentrate” means the waste byproduct of the reverse osmosis desalination process.

As used herein, the term “disk assembly” is the moving component of a valve attached to a stem, which comes in contact with the valve seat to form a seal. A disk assembly may be a non-actuated disk assembly or an actuated disk assembly.

As used herein, the term “feed” means the solute stream which is to be desalinated.

As used herein, the term “function” as applied to a valve means any utilitarian feature of a valve including whether it regulates the flow of seawater, concentrate or other fluid, whether it is actuated or non-actuated, the position of the valve within the work exchanger, whether the valve operates as a poppet valve or check valve, is multi-directional or uni-directional, or any other valve characteristic related to function.

As used herein, the terms “interchangeable orifice” or “interchangeable orifice component,” “orifice,” “passage,” “orifice passage” or “orifice aperture” mean a valve component having an orifice, passage, or configuration to facilitate pressurization and depressurization and to control the flow of fluid which may be removed, replaced or selectively included within a valve. Interchangeable orifice components include, but are not limited to, components having varying orifice sizes and geometric configurations.

As used herein, the term “non-actuated valve” is an embodiment of a universal valve that is not controlled by an actuator (e.g., including but not limited to a seawater valve that opens and closes in response to the pressure and flow of concentrate through the actuated concentrate valves).

As used herein, the term “plenum” means any cavity or interior space within a valve body.

As used herein, the term “poppet valve” means a valve having a stem assembly, a seat and a valve disk.

As used herein, the terms “pressurization” and “de-pressurization” mean a controlled change of the pressure state of a work exchanger vessel, valve, piping and/or any other work exchanger component.

As used herein, the term “protuberance” means any protruding structural configuration to facilitate pressurization and de-pressurization in combination with an orifice.

As used herein, the terms “reverse osmosis membrane” or “semi-permeable membrane” mean a semi-permeable membrane or array of membranes used in the reverse osmosis desalination process known in the art.

As used herein, the term “seat” is the interior surface in the body of the valve that comes in contact with the valve disk to form a seal, and may be of the same or different material than the valve body. The seat may be integrally constructed or a separate component from the valve body. A seat may differ in design and configuration for an actuated valve and a non-actuated valve. A seat may be a separately configured and selectively attachable component, which may or may not be universal.

As used herein, the term “septum” means a component within a work exchanger vessel which separates the solute and concentrate. The septum may be a physical component or a zone created by the interface between the solute and concentrate.

As used herein, the term “stem assembly” is any shaft attached to a valve disk and/or disk assembly. A stem assembly may be an actuated stem assembly configured for attachment to an actuator or a non-actuated stem assembly.

As used herein, the term “tubular” means any elongated component, including a cylindrical, square, hollow, solid or other elongated structural component.

As used herein, the term “tubular guide” or “tubular valve guide” means a confined area, within which a stem assembly moves thereby defining the plane of motion within which the disk assembly moves.

As used herein, the term “universal” means interchangeable or capable of being combined or reconfigured to serve multiple uses in actuated valves and/or non-actuated valves.

As used herein, the term “universal valve body” means a body of a valve which may be combined with various disk assemblies, seat assemblies, or other interchangeable orifice components.

As used herein, the term “universal valve system” means a system of interchangeable valve components (universal valve components) that may be selected for assembly of both actuated valve and non-actuated valve embodiments within a common valve body.

As used herein, the term “work exchanger” means a device for recovering energy from a process and reusing it in the process.

### BRIEF DESCRIPTION OF THE DRAWINGS

FIG. 1 is a block diagram of an exemplary work exchanger (within dotted lines) applied to reverse osmosis.

FIG. 2 illustrates a universal valve body.

FIG. 3a is a perspective view of non-actuated valve.

FIG. 3b is a sectional view of non-actuated valve in the open position.

FIG. 3c is a sectional view a non-actuated valve in the closed position.

FIG. 4a is a perspective view of an actuated valve.

FIG. 4b is a sectional view of one embodiment of an actuated valve in a partially open position.

FIG. 5a illustrates an exemplary embodiment of an actuated stem having a waisted portion.

FIG. 5b illustrates an exemplary embodiment of an actuated stem in the fully closed position.

FIG. 6a is an exploded view of an exemplary interchangeable orifice component.

FIG. 6b is a perspective view of an exemplary embodiment of an interchangeable orifice component.

FIG. 6c is a sectional view of an exemplary embodiment of an orifice and protuberance set.

### SUMMARY OF THE INVENTION

The invention disclosed herein is a valve for a work exchanger device which can be assembled in various actuated and non-actuated valve embodiments using a common, universal valve body. Acutuated embodiments may further include at least one orifice adapted to provide pressurization or de-pressurization before a disk is lifted off a seat to open or partially open a valve.

The universal valve disclosed herein includes at least one universal valve body having a plenum; at least one disk assembly selected from a group of disk assemblies according to the function of a particular universal valve within the work exchanger device (i.e., as an “interchangeable” disk assembly configured to move slidingly within a universal valve body); and at least one interchangeable stem assembly selected from a group of interchangeable stem assemblies according to the function of a particular universal valve within the work exchanger device (i.e., as an “interchangeable” stem assembly). The stem assembly is fixedly attached to at least one disk assembly, and is further configured to move within a hollow, tubular valve guide. Actuated embodiments of the universal valve include stem and disk components and assemblies configured for attachment to an actuator.

Actuated embodiments of the universal valve disclosed herein further include at least one orifice or orifice passage to substantially balance the pressure across said disk assembly (in a controlled manner) to reduce the energy required to move the disk assembly within the work exchanger device. In particular, the stem assembly may include at least one passage connecting the plenum to the orifice (i.e., orifice passages) to substantially balance the pressure across the disk assembly in order to reduce the energy required to move the disk assembly within the work exchanger device when the passage is in the open position.

In the actuated embodiment, the stem assembly may further include a complementary configuration of orifices and passages which facilitate the de-pressurization of a work exchanger vessel; with the orifices operating to reduce the energy required to move the disk assembly.

### DETAILED DESCRIPTION OF EMBODIMENTS OF THE INVENTION

For promoting an understanding of the present invention, references are made in the text hereof to embodiments of a universal valve, only some of which are depicted in the figures. No limitations on the scope of the invention are intended. One of ordinary skill in the art will readily appreciate that there may be functionally equivalent modifications such as dimensions and size and shape of the components. The inclusion of additional elements will be readily apparent and obvious to one of ordinary skill in the art and all equivalent relationships to those illustrated in the drawings and described in the written description do not depart from the spirit and scope of the present invention. Some of these possible modifications are mentioned in the following description. Therefore, exemplary embodiments shown herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale; emphasis instead is placed upon illustrating the principles of the invention. In addition, in the embodiments depicted herein, like reference numerals in the various drawings refer to identical or near identical structural elements.

Moreover, the terms “substantially” or “approximately” may apply to any quantitative representation without resulting in a change in the basic function to which it is related. For example, one embodiment of the universal valve disclosed herein may include components that serve the function of a poppet valve, check valve, actuated valve, non-actuated valve, seawater valve, or concentrate valve as these terms are defined.

For the purposes of promoting an understanding of the principles of the invention, references will be made to exemplary embodiments illustrated in the drawings and specific language will be used to describe them. No limitation is intended.

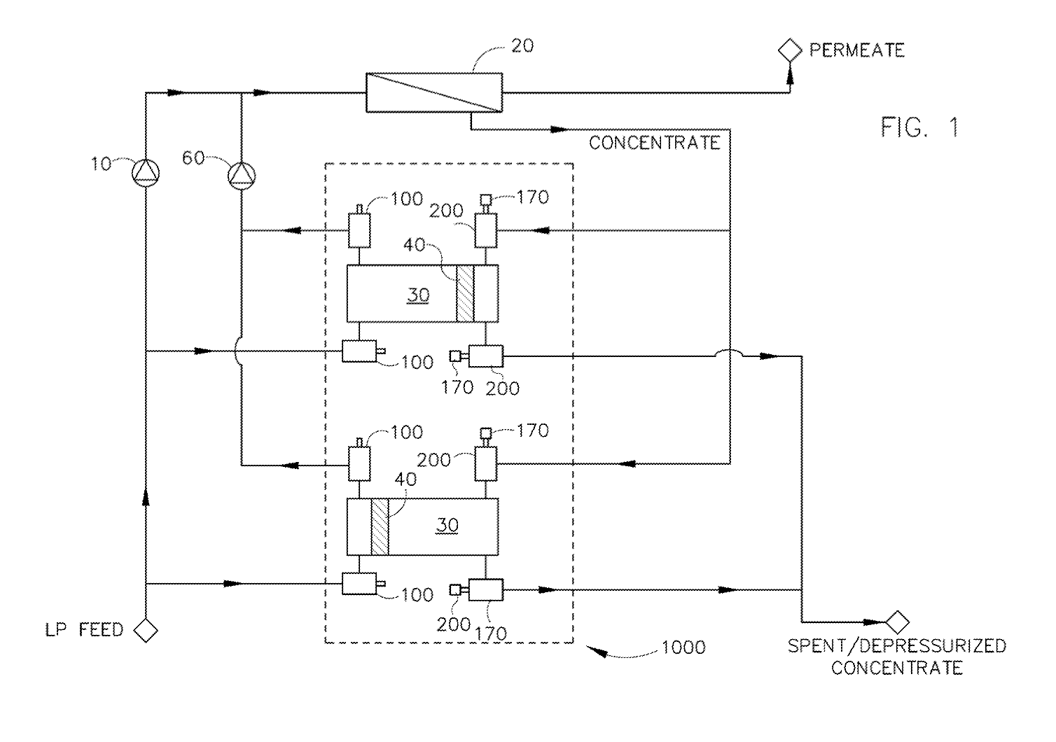

FIG. 1 is a block diagram of an exemplary work exchanger system 1000 for energy recovery within the reverse osmosis process. Work exchanger 1000 utilizes work exchanger vessels 30, work exchanger septum 40, non-actuated valve 100 (which operates as a check valve), and actuated valve 200 with actuator 170 which operates cooperatively with high-pressure feed pump 10, semi-permeable membrane 20, and high-pressure booster pump 60.

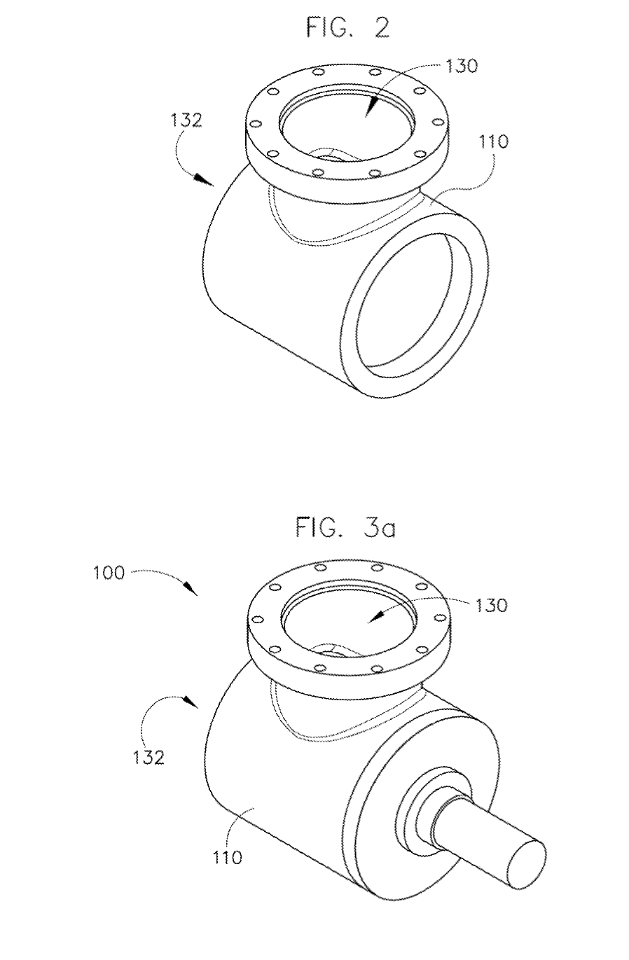

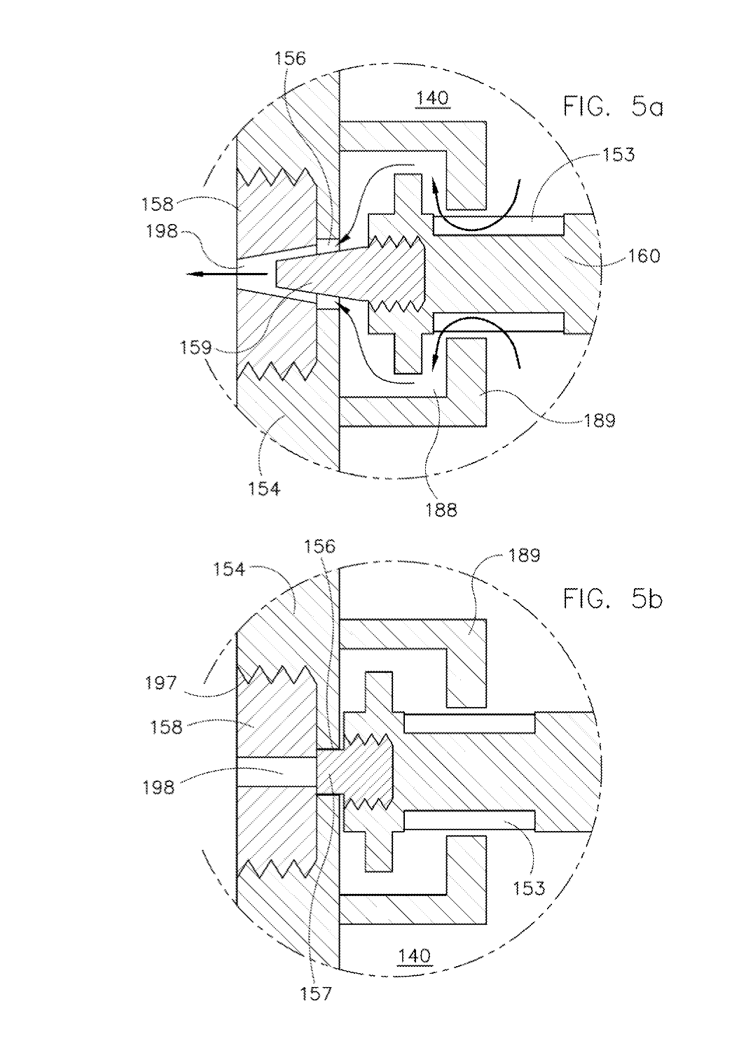

FIG. 2 illustrates universal valve body 110, which is a valve-housing component that may be used in the assembly of both a non-actuated valve 100, as discussed infra, and an actuated valve 200, as discussed infra. Universal valve body 110 can be configured using an array of universal valve components to construct either an actuated valve embodiment or a non-actuated valve embodiment, thus creating valves that have a uniform housing and outer surface components. Universal valve components comprise a system of “modular” or interchangeable valve components to be selected and assembled within universal valve body 110. In the exemplary embodiment shown in FIG. 2, universal valve body 110 is comprised of a generally cylindrical metal housing having side port 130 and end port 132 disposed at one end and one side of universal valve body 110. Additional interchangeable components within this system are discussed infra (e.g. interchangeable orifice component 158 as shown in FIG. 5).

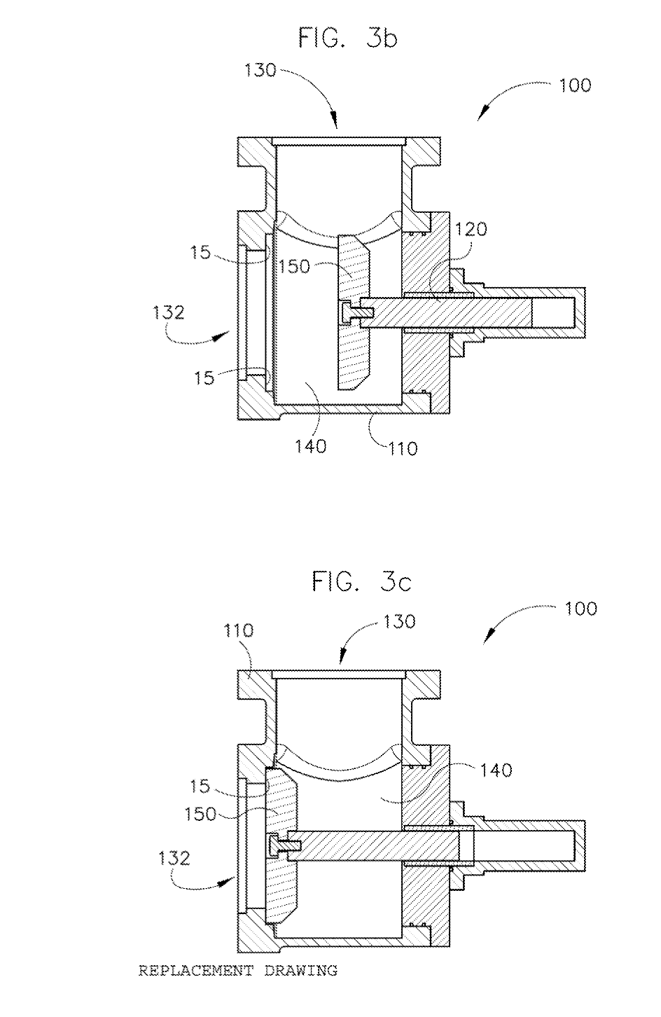

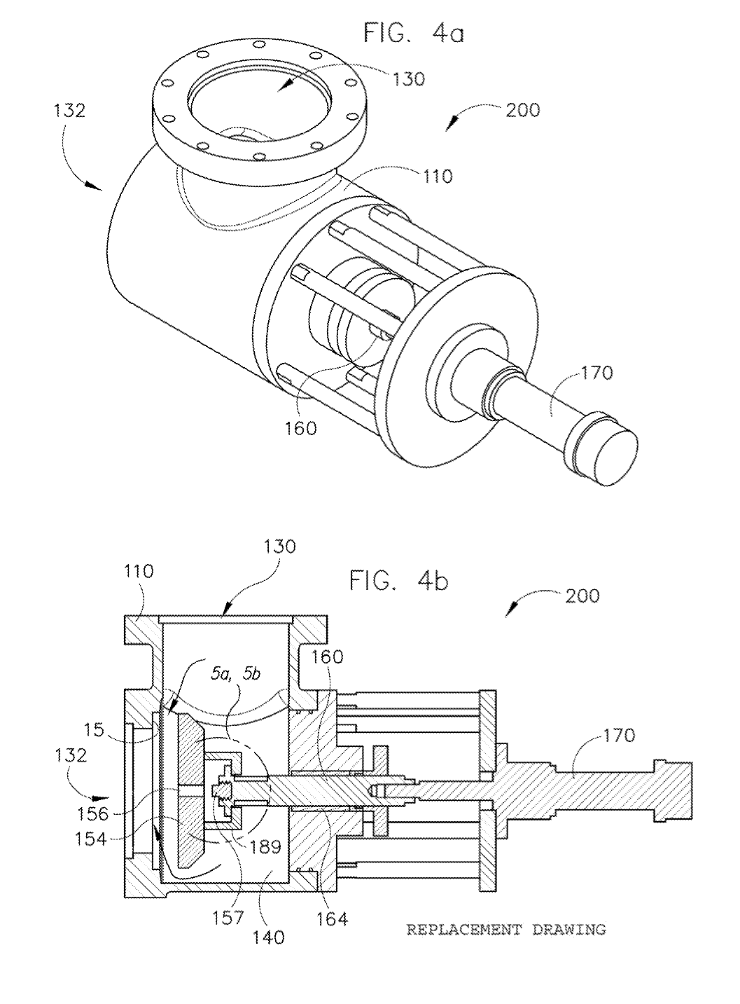

FIG. 3a is a perspective view of non-actuated valve 100 using universal valve body 110, with side port 130 and end port 132. In the embodiment shown in FIG. 3a, non-actuated valve 100 functions as a valve that may be functionally referred to in the art as a “check valve” or “seawater” valve, and which occupies a housing (universal valve body 110) identical to an actuated valve embodiment (discussed infra in FIGS. 4a and 4b).

FIG. 3b is a sectional view of non-actuated valve 100, which is one embodiment which uses universal valve body 110 in the open position. In the exemplary embodiment shown, seat 15 is universal, but in other embodiments seat 15 need not be universal. In the exemplary embodiment shown, seat 15 may be utilized for both actuated (concentrate) and non-actuated (seawater) universal valve assemblies, and may be separately attached or integrally constructed within universal valve body 110. Seat 15 may further be universal (i.e., capable of being used interchangeably with actuated and non-actuated valve embodiments). In various embodiments, seat 15 may be separately attached or integrally constructed within non-actuated disk assembly 150. FIG. 3b further shows side port 130, end port 132, universal valve body 110, non-actuated disk assembly 150, non-actuated stem assembly 120 and plenum 140.

FIG. 3c illustrates a sectional view of the components of non-actuated valve 100 in the closed position. When the pressure is lower inside of plenum 140 than that at the end port 132, non-actuated disk assembly 150 will be lifted off seat 15. When the pressure is greater in plenum 140 than that at the end port 132, non-actuated disk assembly 150 is seated and in contact with seat 15. FIG. 3c also illustrates universal valve body 110 and side port 130.

FIG. 4a is a perspective view of actuated valve 200 (which is a valve embodiment which utilizes universal valve body 110) illustrating an actuated valve embodiment of a valve assembly using universal valve body 110. Actuated stem assembly 160 is a component that is configured so that an actuator may be attached to actuated stem assembly 160. Actuator 170 may be any suitable actuator known in the art (including but not limited to a hydraulic actuator, a pneumatic actuator, an electric actuator or any other actuator known in the art). Universal valve body 110 is comprised of a generally cylindrical metal housing having side port 130 and end port 132 (not visible) disposed at one end and one side of universal valve body 110. Actuated disk assembly 154 (not visible) is moved to either the open or closed position by means of actuator 170 affixed to actuated stem assembly 160.

FIG. 4b is a sectional view of actuated valve 200 in the partially open position and is an embodiment that does not incorporate an interchangeable orifice. In this embodiment, orifice passage 156 can be used to achieve a partial flow through the valve when actuated disk assembly 154 is still seated (not shown), closed by orifice passage seal 157.

FIG. 4b further illustrates universal valve body 110, plenum 140, collar 189, orifice passage 156, and actuated stem assembly 160 that is a component of actuated stem assembly 160. Actuated stem assembly 160 is configured for attachment to actuator 170. Actuator 170 moves actuated stem assembly 160 which moves actuated disk assembly 154. Actuated disk assembly 154 is adapted to conform to the movement of actuated stem assembly 160 to the open or closed position. Universal valve body 110 is comprised of a generally cylindrical metal housing having side port 130 and end port 132 disposed at one end and one side of universal valve body 110. Actuated valve 200 is moved to either the open or closed position by means of actuator 170 affixed to actuated stem assembly 160. Actuator 170 is located externally to the valve body in the embodiments shown and in axial agreement with actuated stem assembly 160, actuated disk assembly 154 and tubular valve guide 164. When actuator 170 is moved to the closed position of the actuated valve 200, actuated stem assembly 160 forces actuated disk assembly 154 tightly against seat 15, and the orifice passage seal 157 (or protuberance 159) closes the orifice passage 156 (or orifice 198) and seals the passage against flow in either direction (Ref. detail in FIGS. 5a and 5b).

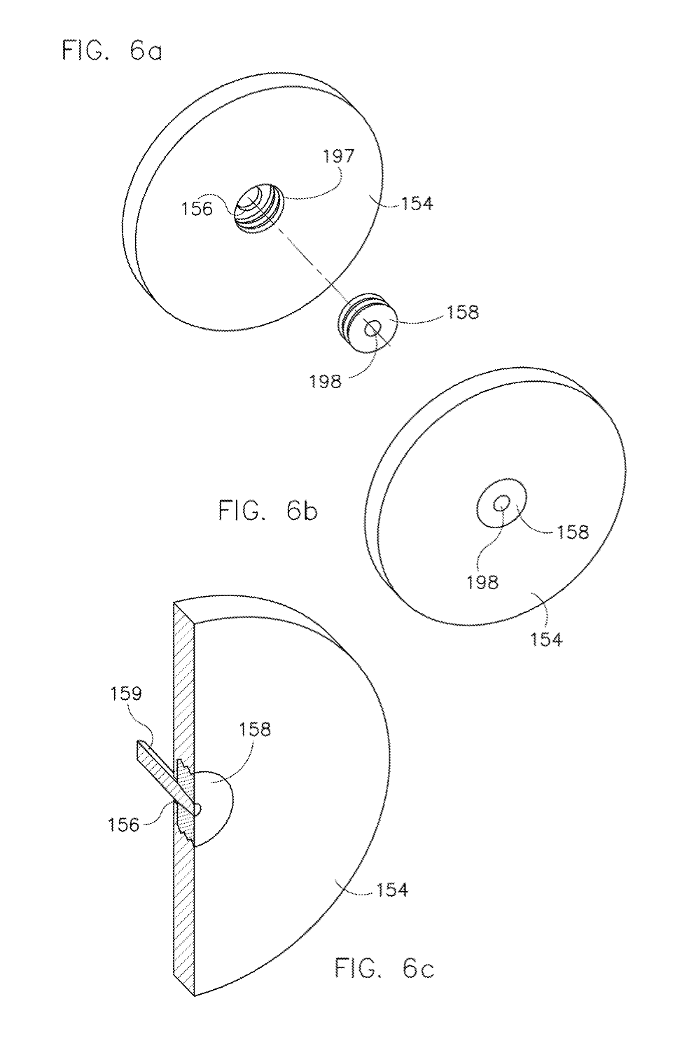

FIGS. 5a and 5b illustrate actuated stem assembly 160 slidingly fixed to the actuated disk assembly 154 by collar 189 of the actuated disk assembly 154. Initial movement of the actuated stem assembly 160 from the closed position removes protuberance 159 (alternate embodiment of orifice passage seal 157 appears in FIG. 5b) from the orifice 198 and allows fluid to move from the higher pressure plenum 140 through annular passage 188, orifice passage 156 and the interchangeable orifice component 158 (discussed infra and illustrated in FIGS. 5a, 5b, 6a, 6b and 6c). Maintaining actuator 170 (not shown) in this position for an adequate time, determined solely by project specific needs based on the volume of the fluid in the project system, ensures that the pressure is equalized or nearly equalized across the valve disk. Alternatively the dimensions of orifice passage 156 and interchangeable orifice component 158 may be made large enough to achieve the equalization or near equalization within the time allowed by the normal movement of actuator 170 (not shown) which is a standard commercially available actuator known in the art. Actuated stem assembly 160 and actuated disk assembly 154 are located axially to the centerline of the valve body 110.

FIGS. 5a and 5b further illustrate the flow of fluid through passages which are spaces created by notches, contouring or other structural configurations of the stem assembly commonly known in the art as a waisted portion. Annular passage 188 is formed within the annular space between collar 189 (a non-stationary but secure point of attachment between valve actuated disk assembly 154 and actuated valve stem assembly 160) and the waisted potion of the actuated stem 153. Annular passage 188 is a channel through collar 189 leading to the orifice passage 156 in actuated disk assembly 154, which allows pressure in the plenum 140 to be released in a controlled fashion that minimizes and/or reduces cavitation and “water hammer.” With the initial movement of valve actuator 170 (not shown), the actuated stem assembly 160 withdraws within the collar 189 of the actuated disk assembly 154 allowing flow through annular passage 188, orifice passage 156 and orifice 198. The smallest diameter of these passages, orifice 198 (which may be the actual, hydraulic or effective diameter) restricts the flow of fluid through the valve prior to the disk being lifted from the valve seat when the valve stem assembly is further moved by actuator 170 (not shown), thus regulating the flow of fluid from plenum 140 which in turn reduces the pressure in plenum 140 and minimizes the pressure differential across one or more surfaces (e.g., the inner surface of the disk which faces plenum 140, allowing the valve to be opened with less energy and be opened and closed with more control. This added control mitigates the phenomena of water hammer and cavitation.

Additional movement of actuator 170 (not shown) in a direction away from the seat 15 (not shown) and end port 132 (not shown) lifts the actuated disk assembly 154 off the seat 15 (not shown) with the minimum amount of energy as the pressure on either side of the poppet valve disk assembly is now equalized. This process is repeated continuously back and forth between the two pressure vessels and their connecting valve assemblies.

Complete sealing of the orifice passage 156 is desirable but not mandatory in a practical embodiment. Complete sealing of the orifice passage 156 to stop partial equalization of pressure can be achieved with the incorporation of a replaceable orifice passage seal 157. Orifice passage seals may be interchangeable to compensate for wear, erosion or other change that may occur over time. It may also be desirable to change the material of orifice passage seal 157 to meet project-specific requirements. The orifice passage seal 157 shall be affixed to the actuated shaft assembly using techniques well known in the art (e.g., threaded, press-fit or other methods suitable for the materials selected for the project). FIGS. 5a and 5b also shows orifice socket 197 within actuated disk assembly 154.

FIGS. 6a and 6b illustrate an exemplary embodiment of interchangeable orifice component 158. FIG. 6a is an exploded view of interchangeable orifice component 158, while FIG. 6b is an assembled view of interchangeable orifice component 158 in actuated disk assembly 154. Actuated valve 200 (FIGS. 4a, 4b) may incorporate interchangeable orifice component 158. Interchangeable orifice components 158 are physical structures in which orifices 198 of varying sizes are mounted in an orifice socket 197 within the actuated disk assembly 154 to narrow the effective diameter (which may be the actual, hydraulic or effective diameter) of the orifice passage 156. In the embodiment shown, in FIGS. 6a, 6b, interchangeable orifice component 158 is a threaded cylindrical component with an orifice 198 that is less in diameter than orifice passage 156. In other embodiments, interchangeable orifice component 158 may be non-threaded, or maybe a shape that is non-cylindrical or irregular, or a structure that partially or substantially blocks flow rather than narrows the diameter of orifice passage 156.

FIG. 6c illustrates orifice protuberance 159. The control achieved by the interchangeable orifice component 158 may be enhanced or alternately achieved by the use of a protuberance 159. Protuberance 159 is positioned within orifice passage 156 and within a tapered version of interchangeable orifice component 158. The use of protuberance 159 with tapered interchangeable orifice component 158 creates a variable area control point. Protuberance 159 may be comprised of interchangeable protuberance components of various lengths and tapers which can be used to improve the effectiveness of the actuated control valve as to minimizing cavitation and mitigating water hammer. The primary dimensions of protuberance 159 (such as length, diameter, taper or length of non-tapered sections), can be calculated based on simple geometric relationships to provide progressive equalization flow rate rather than a sudden abrupt equalization flow. The protuberance geometry can be calculated based on the anticipated movement parameters of a given actuator, such as speed or dwell/delay in certain actuator positions.

Protuberance 159 can be comprised of a number of protuberance components of various geometries in order to improve the effectiveness of the actuated control valve as to minimizing cavitation and mitigating water hammer on a case by case basis since cavitation and water hammer are affected by total system volume due to the compressivity of fluid and expansion of components. The dimensions and shape of the fluid passage area and configuration of orifice and orifice passage 156, interchangeable orifice components 158 and protuberance 159 permit flow of the process fluid from side port 130 to the end port 132 without significant obstruction or pressure loss.

What is claimed:

1. A valve for a work exchanger device comprised of:
at least one universal valve body having a plenum;
at least one interchangeable disk assembly selected from a group of interchangeable disk assemblies according to the function of each said universal valve body within the work exchanger device, each of said at least one disk assembly configured to move slidably within said universal valve body; and
at least one interchangeable stem assembly selected from a group of interchangeable stem assemblies according to the function of each said universal valve body within the work exchanger device, said stem assembly fixedly attached to said at least one disk assembly, said stem assembly selected further configured to move within a hollow, tubular valve guide.

2. The valve of claim 1, wherein said stem assembly is further adapted to facilitate attachment to an actuator.

3. The valve of claim 1, wherein said disk assembly includes at least one orifice to substantially balance the pressure across said disk assembly to reduce the energy required to move said disk assembly within said work exchanger device.

4. The valve of claim 3, wherein said stem assembly includes at least one passage connecting said plenum to said orifice to substantially balance the pressure across said disk assembly to reduce the energy required to move said disk assembly within said work exchanger device when said passage is in the open position.

5. The valve of claim 1, wherein said disk assembly and said stem assembly further include a complementary configuration of orifices and passages which facilitate the de-pressurization of a work exchanger vessel of said work exchanger device, said orifices operating to reduce the energy required to move said disk assembly.

6. The valve of claim 1, wherein said disk assembly and said stem assembly further include a complementary configuration of orifices and passages which facilitate the pressurization of a work exchanger vessel of said work exchanger device; said orifices operating to reduce the energy required to move said disk assembly.

7. The valve of claim 1, wherein said disk assembly and said stem assembly further include at least one orifice which facilitates the de-pressurization of a work exchanger vessel of said work exchanger device, said orifices operating to reduce the energy required to move said disk assembly.

8. The valve of claim 3, which further includes at least one interchangeable orifice component.

9. The valve of claim 3, wherein said stem assembly further includes at least one protuberance which enhances pressurization and de-pressurization.

10. A valve system for a work exchanger device comprised of multiple universal valves each universal valve comprised of:
at least one universal valve body having a plenum;
at least one interchangeable disk assembly selected from a group of interchangeable disk assemblies according to the function of each said universal valve body within the work exchanger device, each of said at least one disk assembly configured to move slidably within said universal valve body; and
at least one interchangeable stem assembly selected from a group of interchangeable stem assemblies according to the function of each said universal valve body within the work exchanger device, said stem assembly fixedly attached to said at least one disk assembly, said stem assembly selected further configured to move within a hollow, tubular valve guide.

11. The valve system of claim 10, wherein each said universal valve further includes a stem assembly further adapted to facilitate attachment to an actuator.

12. The valve system of claim 10, wherein said each said universal valve further includes a disk assembly, said disk assembly further including at least one orifice to substantially balance the pressure across said disk assembly to reduce the energy required to a move said disk assembly within said work exchanger device.

13. The valve system of claim 12, wherein said stem assembly includes at least one passage connecting said plenum to said orifice to substantially balance the pressure across said disk assembly to reduce the energy required to move said disk assembly within said work exchanger device when said passage is in the open position.

14. The valve system of claim 10, wherein said disk assembly and said stem assembly further include a complementary configuration of orifices and passages which facilitate the de-pressurization of a work exchanger vessel of said work exchanger device, said orifices operating to reduce the energy required to move said disk assembly.

15. The valve system of claim 10, wherein said disk assembly and said stem assembly further include a complementary configuration of orifices and passages, which facilitate the pressurization of a work exchanger vessel of said work exchanger device, said orifices operating to reduce the energy required to move said disk assembly.

16. The valve system of claim 10, wherein said disk assembly and said stem assembly further includes at least one orifice which facilitates the de-pressurization of a work exchanger vessel of said work exchanger device, said orifices operating to reduce the energy required to move said disk assembly.

17. The valve system of claim 10, which further includes at least one interchangeable orifice component.

18. The valve system of claim 10, wherein said stem assembly further includes at least one protuberance which enhances pressurization and de-pressurization.

19. A valve system for a work-exchanger device comprised of multiple universal valves each universal valve comprised of:
at least one universal valve body having a plenum;
at least one interchangeable disk assembly selected from a group of interchangeable disk assemblies according to whether said universal valve body is used to regulate the flow of seawater or concentrate within said work exchanger device, each of said at least one disk assembly configured to move slidably within said universal valve body;
at least one interchangeable stem assembly selected from a group of interchangeable stem assemblies according whether said universal valve body is used to regulate the flow of seawater or concentrate within said work exchanger device, said stem assembly fixedly attached to said at least one disk assembly, said stem assembly selected further configured to move within a hollow, tubular valve guide; and
a complementary configuration of orifices included within said disk assembly and passages included within said stem assembly which facilitate the pressurization of a work exchanger vessel of said work exchanger device, said orifices operating to reduce the energy required to move said disk assembly.

20. The valve system of claim 19 wherein said stem assembly may be adapted to facilitate attachment of an optional actuator to move said stem assembly and said disk assembly.

21. The valve system of claim 19 wherein said disk assembly is selected from said group of disk assemblies and said stem assembly is selected from said group of stem assemblies based on whether the said universal valve includes said optional actuator.
